(19) United States
(12) Patent Application Publication
(10) Pub. No.: US 2005/0255882 A1
(43) Pub. Date: Nov. 17, 2005

(54) COMMUNICATION APPARATUS CONTROL METHOD

(76) Inventor: Ying-Kun Tsao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,403

(22) Filed: Nov. 9, 2004

(30) Foreign Application Priority Data
May 17, 2004 (TW) 93113806

(51) Int. Cl. H04Q 7/20

(52) U.S. Cl. 455/556.1; 455/567; 455/426.1; 455/552.1

(57) ABSTRACT

A communication apparatus and a control method thereof adapted to switch environment of a cellular phone are disclosed. The method sets the communication apparatus in a first mode. The first mode automatically switches into a second mode during the execution of the build-in function of the communication apparatus. The build-in function includes receiving/transmitting E-mail, website browsing, photographing and music. The second mode responds to the environment of the execution of the build-in function. By such switching, the execution of the multi-media operation is not interrupted when the communication apparatus receives an electrical message.

### CROSS-REFERENCE TO RELATED APPLICATION

This application claims the priority benefit of Taiwan application serial no. 93113806, filed May 17, 2004.

### BACKGROUND OF THE INVENTION

1. Field of the Invention

The present invention relates to a communication apparatus control method, and more particularly to a communication apparatus control method adapted to prevent interruption during multi-media operation.

2. Description of the Related Art

By continuous development, communication devices like cellular phones have more and more variety of functions for different purposes. For example, the technology of call notification evolves from mono ring tones, electronic music, polyphonic ring tones, self-composed music by recoding and arranging music downloaded via internet to vibration notification, beeping notification and display of words or pictures. These various notification modes are applied in response to different environments.

Latterly, some multi-media functions are integrated in cellular phones, such as receiving/sending e-mails, surfing internet, photographing, videotaping and playing music. With these multi-media functions, cellular phones become a multiple-function device comprising functions of cameras, videotapes and walkmans. By the multiple functions, cellular phones serve the communication function as well as the multi-media function.

Cellular phones are in normal mode during the execution of the multi-media operation. When cellular phones receive phone calls or short messages, call notifications or short message notifications alert users. Under the normal mode, cellular phones generate ring tones or vibrations to alert the users. When cellular phones received phone calls or short messages, these ring tones or vibrations affect or interrupt the execution of the multi-media operation for cellular phones with the functions of photographing or videotaping. For example, when cellular phones receive phone calls during a video conference, the operation of video conference must be stopped, or the vibrations result in image shifts or the ring tones are recoded.

Before the multi-media operation of the cellular phone is used, the operational mode of the cellular phone must be manually switched to another mode under which the execution of the multi-media operation is not interrupted. The cellular phone will not show any message even receiving a phone call or a short message. It may also alert a user by showing words, pictures or animation on the screen of the cellular phone or flashing. After the execution of the multi-media operation, the cellular phone must be switched to a normal mode with the function of vibration or ring tones. Under such normal mode, the cellular phone can performs call notification function.

Each multi-media function has its own environment. Prior to finishing the execution of each multi-media operation, the environment of the cellular phone must be changed responding thereto. After the execution of each multi-media operation, the cellular phone must be switched to the normal mode. By repetitively switching, the operation of the cellular phone is more complicated and inconvenient. Failure of switching the cellular phone to the mode that prevents interruption of a phone call or a short message results in or interference for the multi-media operation of the cellular phone. Failure to switch the cellular phone into the normal mode causes loss of receiving a phone call or a short message.

### SUMMARY OF THE INVENTION

The present invention is also directed to a control method of a communication apparatus. The method automatically converts a received electrical message in response to the execution of the multi-media function.

In order to achieve the goals described above, the present invention discloses a control method of a communication apparatus. The control method executes a first parameter document to set the communication apparatus as a first mode, wherein the first parameter document is contained in a function document, and the function document contains at least one parameter document; receives a control signal; compares the control signal with the function document to obtain a comparing result, and uses the comparing result to execute a second parameter document to switch the communication apparatus to a second mode from the first mode, wherein the parameter document corresponds to the control signal; and receives an electrical message and represents the electrical message on the communication apparatus according to the second parameter document, wherein the first parameter document has different content comparing with the second parameter document.

In one embodiment, the first mode of the control method has at least one of the functions that include ring tones, vibration and displaying on screen.

In one embodiment, the second mode of the control method has at least one of the functions that include no ring tones, novibration and displaying on screen.

In one embodiment, the control signal is used to execute at least one of E-mail receiving/transmitting, website browsing, photographing and music playing, and the executed parameter document is determined by the type of the control signal.

In one embodiment, the control method further receives a responding signal and executes the first parameter document for switching the communication apparatus back to the first mode from the second mode, wherein the responding signal is sent for responding the electrical message. Moreover, the electrical message is converted into words, pictures, animation or flash for function of notification

In another respect, the present invention provides a control method of a communication apparatus to achieve the above-mentioned goals. The control method executes a first parameter document to set the communication apparatus as a first mode, wherein the first parameter document is contained in a function document, and the function document contains at least one parameter document; receives a first control signal; compares the first control signal with the function document to obtain a comparing result, and uses the comparing result to execute a second parameter document to switch the communication apparatus to a second mode from the first mode, wherein the parameter document corresponds to the first control signal; receives an electrical message and represents the electrical message on the communication apparatus according to the second parameter document, wherein the first parameter document has different content comparing with the second parameter document; receives a responding signal and executes a third parameter document for switching the communication apparatus to a third mode from the second mode, wherein the responding signal is sent for responding the electrical message; detects and receives a second control signal and compares the second control signal with the function document; and executes a fourth parameter document for switching the communication apparatus to a fourth mode from the third mode.

In one embodiment, the first mode of the control method has at least one of the functions that include ring tones, vibration and displaying on screen.

In one embodiment, the second mode of the control method has at least one of the functions that include no ring tones, no-vibration and displaying on screen.

In one embodiment, the first control signal is used to execute at least one of E-mail receiving/transmitting, website browsing, photographing and music playing, and the executed parameter document is determined by the type of the first control signal.

In one embodiment, the fourth parameter document equals to the second parameter document, and the fourth mode equals to the second mode.

Accordingly, the present invention provides a control method of a communication apparatus that automatically switches the operation mode in response to an out coming signal without manually switching. The method sets the communication apparatus to a first mode and automatically switches the communication apparatus to a second mode when executing build-in functions, wherein the second mode is defined corresponding to the desired environment of the executed build-in function. By the automatic switch, the execution of the build-in function is not interrupted when the out coming signal is received.

Accordingly, the control method may automatically switch the operation mode during the execution of the build-in function without manually switching. By the automatic switch, the execution of the build-in function operation is not interrupted or affected.

Accordingly, the communication apparatus may not be interrupted when executing a build-in function, and therefore the communication apparatus has better performance. The control method provided by the present invention automatically switches representation type of the received electrical message in response to whether the communication apparatus executes build-in functions. The present invention provides advantages and practical values described above, and no similar technique or structure is disclosed before. The present invention obviously has an inventive step and much better performance comparing with the old ones.

In order to make the aforementioned and other objects, features and advantages of the present invention understandable, a preferred embodiment accompanied with figures is described in detail below.

### BRIEF DESCRIPTION OF THE DRAWINGS

FIG. 1 is a schematic flowchart of a control method of a communication apparatus according to an embodiment of the present invention.

FIG. 2 is a schematic flowchart of a control method of a communication apparatus according to another embodiment of the present invention.

FIG. 3 is a schematic circuit block diagram of a communication apparatus according to an embodiment of the present invention.

### DESCRIPTION OF SOME EMBODIMENTS

For further describing the technique used by the present invention for achieving the goals and advantages stated above, description and associated drawings are made as follows for explaining embodiments of structures, control methods, steps, features and effects.

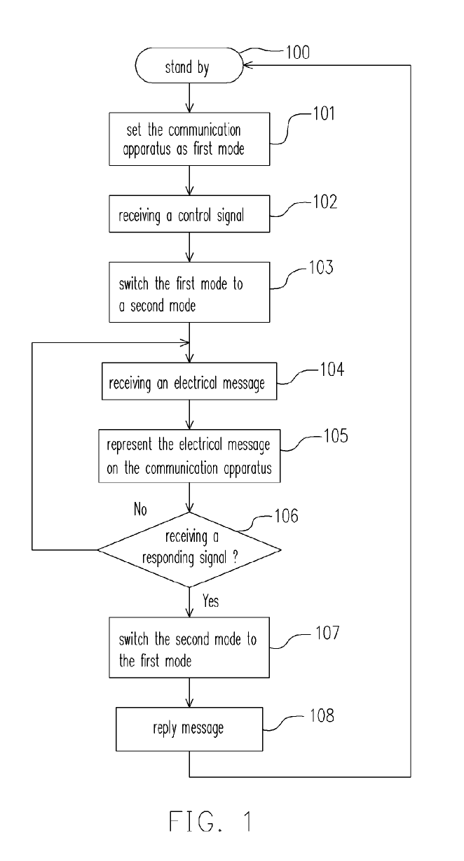

FIG. 1 is a schematic flowchart of a control method of a communication apparatus according to an embodiment of the present invention. Referring to FIG. 1, this embodiment discloses a control method of a communication apparatus. The control method switches a representation type of an electrical message (e.g. incoming call notification or message) between words, pictures, animations or flashlight according to a mode of the communication apparatus for notifying the user. The mode includes at least a first mode and a second mode. The first mode has at least one of the functions that include ring tones, vibration and displaying on screen (hereinafter, setting A). The second mode has at least one of the functions that include no ring tones, no-vibration and displaying on screen (hereinafter, setting B).

In the embodiment, the control method mainly includes the steps described as follows. When the communication apparatus is in a stand by mode (Step 100), a first parameter document is executed to set the communication apparatus to the first mode (Step 101). The first parameter document is contained in a function document, and the function document may contain a plurality of parameter documents. While entering multi-media function, such as E-mail receiving/transmitting, website browsing, photographing and music playing, a control signal is received (Step 102) and compared with the function document for executing a second parameter document for automatically switching the mode of the communication apparatus from the first mode to a second mode (Step 103). The content of the first parameter document is different from that of the second parameter document. When an electrical message is received under the second mode (Step 104), the electrical message is represented on the communication apparatus according to the content of the second parameter document (Step 105) for notifying the user without interrupting the multi-media function, and then the user may decide whether to respond or not. If the user decides to respond, a responding signal is sent out by the user, for example by pressing a special button, and the communication apparatus receives the responding signal (Step 106) and executes the first parameter document for switching the second mode to the first mode (Step 107). User may reply the incoming call or message (Step 108) and the communication apparatus returns to the standby mode after user replies the call or message (Step 100).

On the contrary, if the user does not want to reply the received message when the electrical message is received (Step 104), i.e., if the user does not want to finish the multi-media function, the communication apparatus will stay in the second mode. The communication apparatus would not return to the first mode until the user decides to finish the multi-media function.

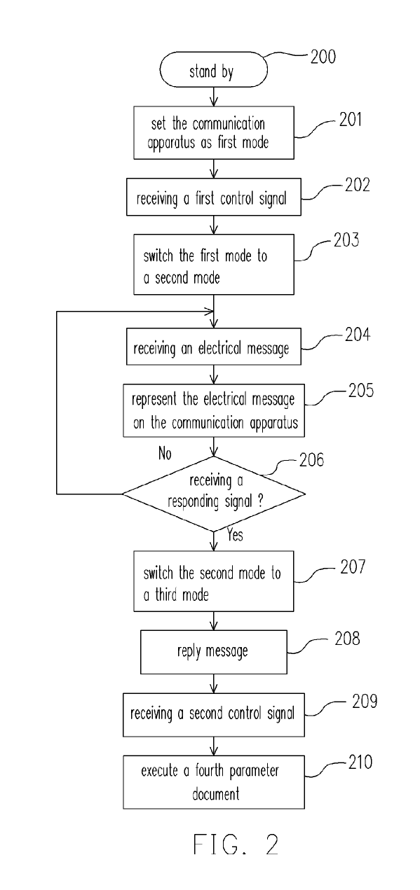

FIG. 2 is a schematic flowchart of a control method of a communication apparatus according to another embodiment of the present invention. Referring to FIG. 1, this embodiment discloses a control method of a communication apparatus. The control method mainly includes the steps described as follows. When the communication apparatus is in a stand by mode (Step 200), a first parameter document is executed to set the communication apparatus to the first mode (Step 201). The first parameter document is contained in a function document, and the function document may contain a plurality of parameter documents. While entering multi-media function, such as E-mail receiving/transmitting, website browsing, photographing and music playing, a first control signal is received (Step 202) and compared with the function document for executing a second parameter document for automatically switching the mode of the communication apparatus from the first mode to a second mode (Step 203). The content of the first parameter document is different from that of the second parameter document. When an electrical message is received under the second mode (Step 204), the electrical message is represented on the communication apparatus according to the content of the second parameter document (Step 205) for notifying the user without interrupting the multi-media function, and then the user may decide whether to respond or not. If the user decides to respond, a responding signal is sent out by the user, and the communication apparatus receives the responding signal (Step 206) and executes a third parameter document for switching the communication apparatus to a third mode (Step 207). A temporary document may be recorded to save the status of the communication apparatus at Step 207 as well. The communication apparatus holds the multi-media operation and allows the user to reply messages (Step 208). After replying messages, the communication apparatus receives a second control signal (Step 209), which may be generated by pressing a special button, to allow the user to determine whether the representing type of the incoming electrical messages should be changed. If the user wanted to change the representing type of the electrical message, the second control signal would be compared with the function document. After comparing, the communication apparatus may switch to a fourth mode from the third mode by executing a fourth parameter document according to the result obtained by the comparing. The temporary document might be read if it is necessary (Step 210). Furthermore, when the second control signal equals to the first control signal, the fourth parameter document has equal content comparing with the second parameter document, and the fourth mode has equal setting comparing with the second mode. That is to say, if the second control signal equals to the first control signal, the communication apparatus will re-perform the multi-media operation. On the contrary, if the representing type of the electrical message should be remained, the communication apparatus would execute the second parameter to switch the communication apparatus back to the second mode, read the temporary document and continue performing the multi-media operation.

On the contrary, if the user does not want to reply the received message when the electrical message is received (Step 204), i.e., if the user does not want to finish the multi-media function, the communication apparatus will stay in the second mode. The communication apparatus would not return to the first mode until the user decides to finish the multi-media function.

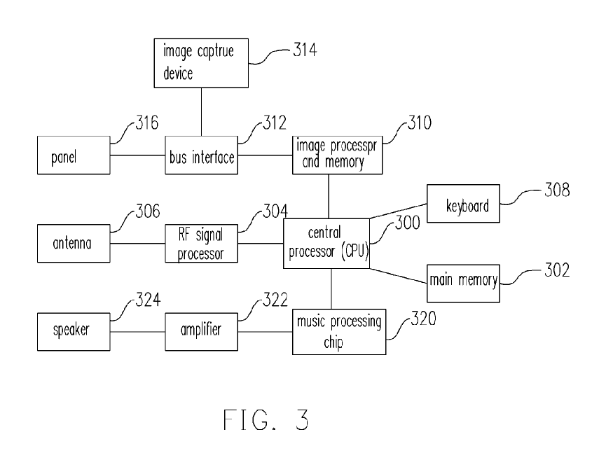

FIG. 3 is a schematic circuit block diagram of a communication apparatus according to an embodiment of the present invention. The communication apparatus comprises: a central processor 300, a main memory 302 and an electrical message receiving module. The main memory is adapted to store a plurality of parameter documents and coupled to the central processor 300. The electrical message receiving module is adapted to receive an electrical message. The electrical message receiving module comprises a radio frequency (RF) processor 304 coupled to the central processor 300 and an antenna 306 coupled to the RF processor 304.

The central processor 300 converts a received electrical message by accessing one of the parameter documents stored in the main memory according to an operation mode of the communication apparatus. The accessed parameter document determines an environmental parameter set. The received electrical message is converted into ring tones, vibration, or display of words or pictures on the panel of the cellular phone according to the environmental parameter set.

For example, when a cellular phone is in stand-by mode, the central processor 300 accesses the setting A stored in the main memory 302 which performs notification by ring tones, vibration and display of words or pictures on the panel of the cellular phone when the cellular phone receives a phone call or a short message. The multi-media operation can be activated by inputting commands via a keyboard 308. The central processor 300 automatically switches into the setting B stored in the main memory 302 which does not perform ring tones and vibration, or displays words or pictures on the panel of the cellular phone when the cellular phone receives a phone call or a short message. The central processor 300 also controls an image processor 310, activating an image capture device 314 via a bus interface 312 and displaying images on a panel 316 for the multi-media function like photographing or videotaping.

When receiving a phone call or a short message during the execution of the multi-media operation like photographing or videotaping, the antenna 306 transmits the received electrical message to the central processor 300 via the RF processor 304. The central processor 300 converts the received electrical message without interrupting the execution of the multi-media operation according to the setting B. The received signal can be converted into, for example, words, pictures, animation or flash for the purpose of notification.

If the received electrical message is not going to be replied, the execution of the multi-media operation keeps going until finished. When the user terminates the multi-media operation of photographing or videotaping via the keyboard 308, the central processor 300 automatically accesses the setting A stored in memory 302, while turning off the image capture device 314 via the image processor 310. If the user is going to reply the received electrical message, the central processor 300 may proceeds one of the two procedure as follows:

1. The central processor 300 automatically accesses the setting A stored in memory 302 to terminate the multi-media operation. The communication apparatus then replies the received electrical message via a music processing chip 320, an amplifier 322 and a speaker 324 coupled to the central processor 300. After replying the received electrical message, the communication apparatus stays in stay-by mode.

2. The central processor 300 automatically accesses the setting A stored in memory 302 to hold the multi-media operation, and stores the status of the multi-media operation in a temporary document. The communication apparatus then replies the received electrical message via a music processing chip 320, an amplifier 322 and a speaker 324 coupled to the central processor 300. After replying the received electrical message, the communication apparatus is switched back to the setting B. The temporary document is read and the multi-media operation is continued.

The prior art communication apparatus, when receiving a phone call or a short message, causes vibration or ring tones during the execution of the multi-media operation. The vibration and ring tones result in image shift or the recording of the ring tones. To resolve the issue, the prior art communication apparatus has to terminate the multi-media operation. The communication apparatus and the control method thereof according to the present invention solve the problem. The present invention automatically switches from the normal mode into the multi-media operational mode during the multi-media operation of the communication apparatus. Accordingly, when the communication apparatus receives a phone call or a short message, the multi-media operation is not affected by vibration or ring tones of the cellular phone. The multi-media operation is also not terminated by the interference of such vibration or ring tones of the cellular phone.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A control method of a communication apparatus, comprising:
(a) executing a first parameter document to set the communication apparatus as a first mode, wherein the first parameter document is contained in a function document, and the function document contains at least one parameter document;
(b) receiving a control signal;
(c) comparing the control signal with the function document to obtain a comparing result, and using the comparing result to execute a second parameter document to switch the communication apparatus to a second mode from the first mode, wherein the parameter document corresponds to the control signal; and
(d) receiving an electrical message and representing the electrical message on the communication apparatus according to the second parameter document, wherein the first parameter document has different content comparing with the second parameter document.

2. The control method of claim 1, wherein the first mode includes at least one of ring tones, vibration and displaying on screen.

3. The control method of claim 1, wherein the second mode includes at least one of no ring tones, no-vibration and displaying on screen.

4. The control method of claim 1, wherein the control signal is used to execute at least one of E-mail receiving/transmitting, website browsing, photographing, videotaping and music playing, and the executed parameter document is determined by a type of the control signal.

5. The control method of claim 1, further comprising:
(e) receiving a responding signal and executing the first parameter document for switching the communication apparatus back to the first mode from the second mode, wherein the responding signal is sent for responding the electrical message.

6. A control method of a communication apparatus, comprising:
(a) executing a first parameter document to set the communication apparatus as a first mode, wherein the first parameter document is contained in a function document, and the function document contains at least one parameter document;
(b) receiving a first control signal;
(c) comparing the first control signal with the function document to obtain a comparing result, and using the comparing result to execute a second parameter document to switch the communication apparatus to a second mode from the first mode, wherein the parameter document corresponds to the first control signal;
(d) receiving an electrical message and representing the electrical message on the communication apparatus according to the second parameter document, wherein the first parameter document has different content comparing with the second parameter document;
(e) receiving a responding signal and executing a third parameter document for switching the communication apparatus to a third mode from the second mode, wherein the responding signal is sent for responding the electrical message;
(f) detecting and receiving a second control signal and comparing the second control signal with the function document; and
(g) executing a fourth parameter document for switching the communication apparatus to a fourth mode from the third mode.

7. The control method of claim 6, wherein the first mode includes at least one of ring tones, vibration and displaying on screen.

8. The control method of claim 6, wherein the second mode includes at least one of no ring tones, no-vibration and displaying on screen.

9. The control method of claim 6, wherein the first control signal is used to execute at least one of E-mail receiving/transmitting, website browsing, photographing, videotaping and music playing, and the executed parameter document is determined by a type of the first control signal.

10. The control method of claim 6, wherein when the second control signal equals to the first control signal, the fourth parameter document has equal content comparing with the second parameter document, and the fourth mode has equal setting comparing with the second mode.

11. The control method of claim 6, wherein after the step (e) further performs:
(e1) recording a temporary document when executing the third parameter document.

12. The control method of claim 11, wherein after the step (f) further performs:
(f1) reading the temporary document when executing the fourth parameter document.
